(19) United States
(12) Patent Application Publication
(10) Pub. No.: US 2009/0028154 A1
(43) Pub. Date: Jan. 29, 2009

(54) Method And Device For Learning Forwarding Feature Information

(75) Inventor: Zhangzhen Jiang, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/239,894

(22) Filed: Sep. 29, 2008

Related U.S. Application Data
(63) Continuation of application No. PCT/CN2007/001019, filed on Mar. 29, 2007.

(30) Foreign Application Priority Data
Mar. 29, 2006 (CN) 200610073421.2

(51) Int. Cl. H04L 12/56

(52) U.S. Cl. 370/392

(57) ABSTRACT

A method and device for learning data forwarding information includes a forwarding table recording forwarding feature information stored in a switch device, and wherein corresponding service importance levels for the forwarding feature information are configured. The method includes receiving new forwarding feature information, determining whether the forwarding table is full; if full, determining whether to write the new forwarding feature information into the forwarding table according to the service importance level of the new forwarding feature information; otherwise recording the new forwarding feature information into the forwarding table, and recording service importance level corresponding to the new forwarding feature information. The disclosure also provides a device for learning data forwarding information.

### CROSS-REFERENCE TO RELATED APPLICATIONS

This application is a continuation of International Application No. PCT/CN2007/001019, filed Mar. 29, 2007. This application claims the benefit and priority of Chinese Application No. 200610073421.2, filed Mar. 29, 2006. The entire disclosures of each of the above applications are incorporated herein by reference.

### FIELD

The present disclosure relates to the field of data communications and in particular to a method and device for learning data forwarding information.

### BACKGROUND

This section provides background information related to the present disclosure which is not necessarily prior art.

There is a need of forwarding a large amount of data through forwarding devices in data communications, and the forwarding devices need to self-learn forwarding information. For instance, when an Ethernet switch receives a MAC frame through an interface in the Ethernet switch, a primary task of the switch is to find an output interface according to a destination address of the MAC frame and forward the MAC frame to the output interface.

Typically, a forwarding table is present in the Ethernet switch, and an output interface is selected for each MAC frame from the table according to the destination address of the received MAC frame. There are the following two routing approaches.

(1) Fixed Routing

In the fixed routing, there is a manually configured forwarding table in which each interface and its corresponding destination address are specified. Although the fixed routing is a kind of routing approach, configuration of the forwarding table becomes a burdensome task in the case of an excessively large scale of a network. In addition to this, configuration of the network may often be altered or a host may be added or deleted in the network where the switch is located, and therefore it is difficult for an administrator of the network to timely update the forwarding table so as to adapt it to a topology change.

(2) Self-Learning Routing

In a practical application, a dynamic forwarding table is typically created by a self-learning method to automatically adapt the forwarding table to a topology change of the network. The dynamic forwarding table can be obtained through continuous modification in a self-learning process based upon a manually created forwarding table.

The self-learning means that a forwarding table is created or updated according to a source address of a MAC frame arriving at each interface. It is assumed that a switch receives a MAC frame through an interface X, checks and finds that a source address of the MAC frame is an address A, indicating that any MAC frame having a destination address of the address A shall be forwarded through the interface X. Upon reception of the MAC frame having the source addressing of the address A from the X interface, a control part of the switch checks the forwarding table. If the address A is not included in destination address item in the forwarding table, the content of the address A is added in the destination address item corresponding to the interface X; and if the address A is included in the destination address item in the forwarding table, destination address item nevertheless corresponding to an interface Y, the forwarding table shall be modified.

As can be seen from the above, the Ethernet switch creates a forwarding table using a broadcast frame and self-learning method. Once the forwarding table is configured, routing is selected for a subsequent MAC frame according to a destination MAC address (without any label) and the forwarding table, thereby forming a virtual circuit from a source host to a destination host.

Because the number of the table items which can be stored in a device is limited, recently learnt new forwarding information cannot be stored into the forwarding table if the new forwarding information exceeds the number of the table items which can be stored in the device, or the new forwarding information can be stored only if any other table item is deleted.

The following two solutions for solving this problem have been proposed in the prior art.

First Solution

In the first solution, recently learnt new information can not be recorded into a forwarding table when the forwarding table is full.

In this solution, relatively important new forwarding feature information, though having been learnt, may not be recorded into the forwarding table.

Second Solution

In the second solution, information that is closest to aging or was the first to be learnt is deleted when a forwarding table is full, and new forwarding information can be recorded into the forwarding table.

In this solution, the deleted aged information or the first learnt information may be forwarding information of an important service.

### SUMMARY

This section provides a general summary of the disclosure, and is not a comprehensive disclosure of its full scope or all of its features.

An object of the disclosure is to overcome the drawback present in the prior art that relatively important new forwarding feature information cannot be recorded or stored, and further to provide a method and device for learning data forwarding information. According to this method and device. Forwarding information of a relatively least important service may be deleted so as to ensure that forwarding information of an important service can be stored into a forwarding table.

A method for learning forwarding feature information, in which a corresponding service importance level is configured for the forwarding feature information, includes:

receiving new forwarding feature information;

if the forwarding table is not full, recording the new forwarding feature information into a forwarding table and recording a service importance level corresponding to the forwarding feature information; and

if the forwarding table is full, determining whether to write the new forwarding feature information into the forwarding table according to the service importance level of the new forwarding feature information; and if the service importance level of the new forwarding feature information is higher than the lowest service importance level among the service importance levels corresponding to the forwarding feature information recorded in the forwarding table, deleting a piece of forwarding feature information corresponding to the lowest service importance level in the forwarding table, recording the new forwarding feature information into the forwarding table, and recording the service importance level corresponding to the new forwarding feature information.

A device for learning forwarding feature information includes:

a forwarding table storing module adapted to store a forwarding table recording forwarding feature information;

a service importance level table storing module adapted to record service importance levels corresponding to the forwarding feature information recorded in the forwarding table; and

a forwarding feature information processing module adapted to determine whether the forwarding table is full upon reception of new forwarding feature information;

the device is adapted to:

if the forwarding table is not full, record the new forwarding feature information into the forwarding table and record a service importance level corresponding to the new forwarding feature information into the service importance level table storing module; and

if the forwarding table is full and the service importance level of the new forwarding feature information is higher than the lowest service importance level among service importance levels corresponding to the forwarding feature information recorded in the forwarding table, delete a piece of forwarding feature information corresponding to the lowest service importance level, record the new forwarding feature information into the forwarding table, and record the service importance level corresponding to the new forwarding feature information into the forwarding feature information processing module.

Advantageous effects of the disclosure lie in that important forwarding information can be retained and recorded so as to better serve an important service because of the deletion of information according to service importance of the forwarding feature information.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow diagram of the method for learning data forwarding information according to an embodiment of the present application;

FIG. 2 is a flow diagram of the method for learning data forwarding information according to another embodiment of the present application;

FIG. 3 is a structure diagram of the device for learning data forwarding information according to an embodiment of the present application; and

FIG. 4 is a structure diagram of the device for learning data forwarding information according to another embodiment of the present application.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The disclosure is further described hereinafter by reference to the accompanying drawings and embodiments without limitation thereto.

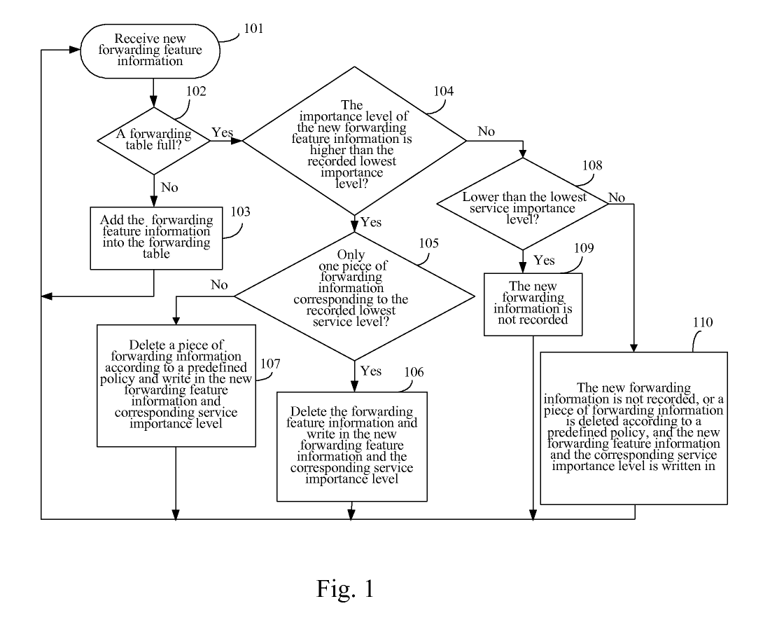

Referring to FIG. 1, a method according to the disclosure is as follows.

At 100, a corresponding service importance level is configured for forwarding feature information, and the service importance level can be configured manually, and also can be generated automatically according to signaling.

Particularly, there may be various criteria for evaluating the importance of a service. For instance, a service of a user is typically subject to stream classification processing at an edge of an operator network. The importance of a stream does not indicate the importance of certain data. For instance, an Ethernet switch is provided with interfaces A, B, C and D. A service over the interface A is the most important and thus a service importance level of 1 is configured for the service, and a service over the interface D is the relatively least important, and thus a service importance level of 4 is configured for the service. All data received over the interface A is important service data, and thus has the service importance level of 1, and so on.

Another way can also be used as a criterion of evaluating the importance of a service. That is, the importance can be ranked according to the form of certain data. For instance, an Ethernet switch is provided with interfaces A, B, C and D. Data in the form of VLAN 100 over each interface is the most important, and thus has a service importance level of 1, and data in the form of VLAN 105 is the relatively least important, and thus has a service importance level of 5. As such, if a service received from an interface is related to the VLAN 100, the service importance level corresponding to the service is 1.

Further, other ways can also be used to indicate the importance of a service.

It is assumed in this embodiment that a corresponding service importance is configured according to an interface.

At 101, a switch receives new forwarding feature information, and the forwarding feature information includes a forwarding source address, a forwarding destination address and a forwarding interface. If the service importance is configured according to another feature. For instance, if the service importance is ranked according to the form of data, the forwarding feature information includes a VLAN ID; if the importance is ranked according to a MAC address, the forwarding feature information includes a corresponding MAC address; and if the importance is ranked according to an IP address, the forwarding feature information includes a corresponding IP address.

At 102, it is determined whether a forwarding table is full; and if not full, the flow goes to a step 103; otherwise, the flow goes to 104.

At 103, the new forwarding feature information received at 101 and the corresponding service importance level are added into the forwarding table, and the flow terminates and is ready for reception of new forwarding feature information again.

In this embodiment, the forwarding table includes the service importance levels corresponding to the forwarding feature information. In practice, the service importance levels can also be listed separately, and a specific data organization mode is not limited, as long as the service importance levels correspond to feature information that can be forwarded.

At 104, it is determined whether the service importance level of the new forwarding feature information is higher than the lowest recorded service importance level; and if there is, the flow goes to 105; otherwise, the flow goes to 108.

At 105, it is determined whether there is only one piece of forwarding feature information corresponding to the lowest recorded service importance level; and if there is, the flow goes to 106; otherwise, the flow goes to 107.

At 106, the piece of the forwarding feature information is deleted, and the new forwarding feature information and the corresponding service importance level are written into the table.

At 107, a piece of forwarding feature information is deleted according to a predefined policy, and the new forwarding feature information and the corresponding service importance level are written into the table. For instance, the deleted forwarding feature information is a piece of forwarding information which is selected randomly from the forwarding feature information corresponding to the lowest service importance level, or which is closest to aging or was the first to be learnt among the forwarding feature information corresponding to the lowest service importance level. The predefined policy can also be configured according to practical circumstances.

At 108, it is determined whether the service importance level of the new forwarding feature information is lower than the lowest one of the service importance levels corresponding to the forwarding feature information in the forwarding table; and if lower, the flow goes to 109; otherwise, the flow goes to 110.

At 109, the new forwarding feature information is not recorded, and reception of new forwarding feature information is started.

At, the new forwarding feature information is not recorded, or a piece of forwarding feature information is deleted according to a predefined policy and the new forwarding feature information and the corresponding service importance level are written into the table. For instance, the deleted forwarding feature information is a piece of forwarding feature information which is selected randomly from the forwarding feature information corresponding to the lowest service importance level, or closest to aging or was the first to be learnt among the forwarding feature information corresponding to the lowest service importance level.

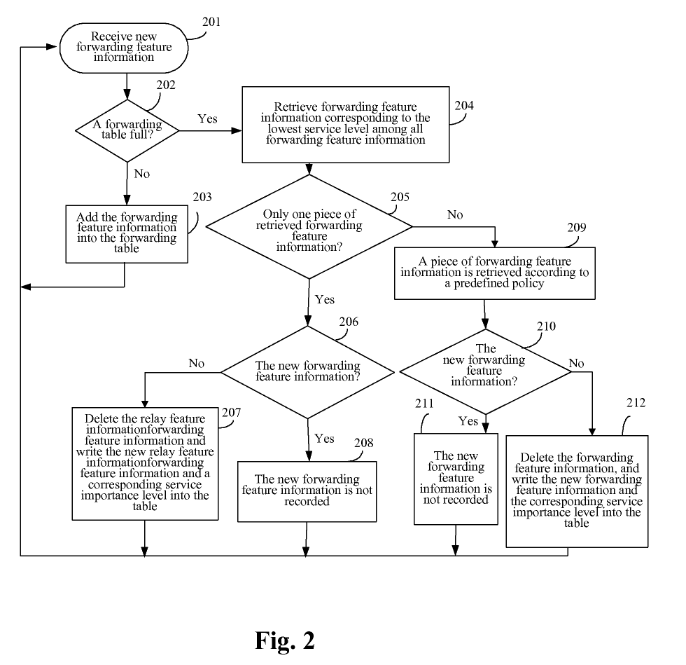

Referring to FIG. 2, the disclosure also provides a second embodiment where 201-203 are substantially identical to those in the preceding embodiment except for a different determination method. A method of the second embodiment is as follows.

At 201, a switch receives new forwarding feature information, and the forwarding feature information includes a forwarding source address, a forwarding destination address and a forwarding interface. If the service importance is configured according to another feature, for instance, if the service importance is ranked according to the form of data, the forwarding feature information includes a VLAN ID; if the service importance is ranked according to a MAC address, the forwarding feature information includes a corresponding MAC address; and if the service importance is ranked according to an IP address, the forwarding feature information includes a corresponding IP address.

At 202, it is determined whether a forwarding table is full; and if not full, the flow goes to 203; otherwise, the flow goes to 204.

At 203, the new forwarding feature information received at 201 and the corresponding service importance level are added into the forwarding table, and the flow terminates and is ready for reception of new forwarding feature information again. In the embodiment, the forwarding table includes the service importance levels corresponding to the forwarding feature information. In practice, the service importance levels can also be listed separately, and a specific data organization mode is not limited, as long as the service importance levels correspond to the feature information that can be forwarded.

At 204, the forwarding feature information corresponding to the lowest service importance level is retrieved from all the forwarding feature information including the new forwarding feature information and the forwarding feature information in the forwarding table.

At 205, it is determined whether there is only one piece of retrieved forwarding feature information; and if there is, the flow goes to 206; otherwise, the flow goes to 209.

At 206, it is determined whether the forwarding feature information is the new forwarding feature information; and if there is, the flow goes to 208; otherwise, the flow goes to 207.

At 207, the forwarding feature information retrieved at 204 is deleted from the forwarding table, and the new forwarding feature information and the corresponding service importance level are written into the forwarding table. Reception of new forwarding feature information is started.

At 208, the new forwarding feature information is not recorded, and reception of new forwarding feature information is started.

At 209, a piece of information is selected from the forwarding feature information retrieved at 204 according to a predefined policy, for instance, the selected forward feature information is a piece of forwarding feature information which is selected randomly or closest to aging or was the first to be learnt.

At 210, it is determined whether the selected information is the new forwarding feature information. If the selected information is the new forwarding feature information, the new forwarding feature information is not recorded at 211; otherwise, the information selected at 209 is deleted from the forwarding table, and the new forwarding feature information and the corresponding service importance level are written into the table.

For instance, an Ethernet switch is provided with four interfaces A, B, C and D. A service over the interface A is the most important, and a service over the interface D is the relatively least important. There are learnt 100 MAC address forwarding table items including 20 items from the interface A, 30 items from the interface B, 20 items from the interface C and 30 items from the interface D.

If an address learning function module of the switch learns an address from the interface A, a forwarding module knows from a record that a service over the interface A is important, and a relatively least important item of the interface D is retrieved and deleted. An item of the interface A is written into the forwarding table. Because the interface D corresponds 30 items at this time, a piece of information is deleted according to a predefined policy. For instance, the deleted forward feature information is a piece of forwarding feature information which is randomly selected or closest to aging or was the first to be learnt.

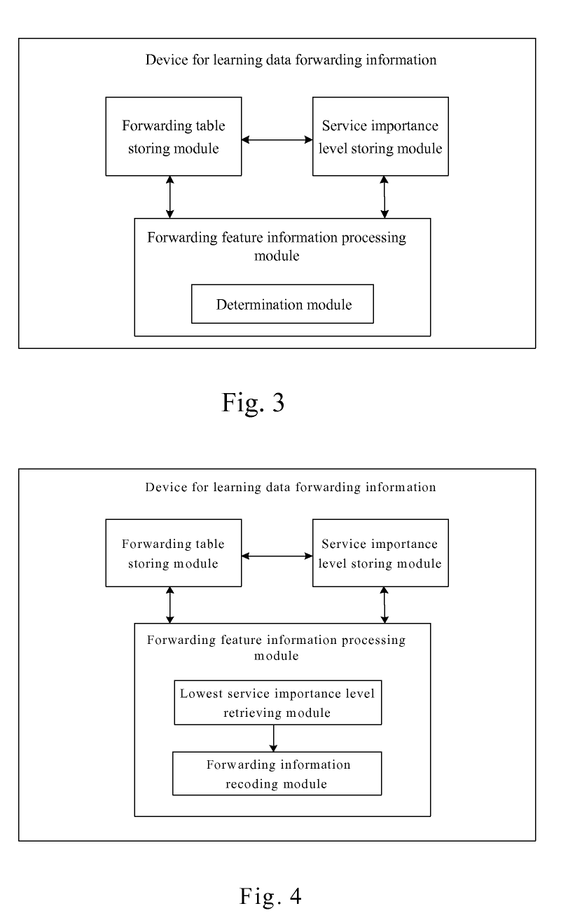

Referring to FIG. 3, the disclosure also provides a device for learning data forwarding information, which device includes a forwarding table storing module for storing a forwarding table, and a service importance level table storing module and a forwarding feature information processing module.

The service importance level table storage module is adapted to store the service importance levels corresponding to the forwarding feature information.

The forwarding feature information processing module is adapted to determine whether the forwarding table is full upon reception of new forwarding feature information; and if full, determine whether to write the new forwarding feature information into the forwarding table according to a service importance level of the new forwarding feature information; otherwise, add the new forwarding feature information into the forwarding table and record the corresponding service importance level.

The forwarding feature information processing module includes a determination module adapted to determine whether the service importance level of the new forwarding feature information is higher than the lowest recorded service importance level, and if higher, the forwarding feature information corresponding to the lowest recorded service importance level, record the new forwarding feature information into the forwarding table, and record the service importance level corresponding to the new forwarding feature information; otherwise, record the new forwarding feature information, or select and delete one piece of forwarding feature information among the forwarding feature information corresponding to the lowest service importance level in the forwarding table according to a predefined policy, record the new forwarding feature information into the forwarding table, and record the service importance level corresponding to the new forwarding feature information.

Referring to FIG. 4, the forwarding feature information processing module in the device of the disclosure may also include a lowest service importance level retrieving module and a forwarding information recording module.

The lowest service importance level retrieving module is adapted to retrieve the lowest service importance level among the service importance level corresponding to the new forwarding feature information and the recorded service importance levels.

The forwarding information recording module is adapted to determine whether the forwarding feature information corresponding to the lowest service importance level is the new forwarding feature information, and if so, the new forwarding feature information is not recorded; otherwise, delete the forwarding feature information corresponding to the lowest service importance level, record the new forwarding feature information into the forwarding table, and record the service importance level corresponding to the new forwarding feature information.

The foregoing descriptions are merely illustrative of the exemplary embodiments, and obvious variations and substitutions which can be made by those skilled in the art without departing from the technical solutions of the disclosure are intended to be encompassed in the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for learning forwarding feature information, comprising:
receiving new forwarding feature information;
if the forwarding table is not full, recording the new forwarding feature information into a forwarding table and recording a service importance level corresponding to the forwarding feature information; and
if the forwarding table is full, determining whether to write the new forwarding feature information into the forwarding table according to the service importance level of the new forwarding feature information.

2. The method according to claim 1, wherein the determining whether to write the new forwarding feature information into the forwarding table according to the service importance level of the new forwarding feature information further comprises:
if the service importance level of the new forwarding feature information is higher than the lowest service importance level among the service importance levels corresponding to the forwarding feature information recorded in the forwarding table, deleting a piece of forwarding feature information corresponding to the lowest service importance level in the forwarding table, recording the new forwarding feature information into the forwarding table, and recording the service importance level corresponding to the new forwarding feature information.

3. The method according to claim 1, further comprising:
not recording the new forwarding feature information if the service importance level of the new forwarding feature information is lower than the lowest service importance level among the service importance levels corresponding to the forwarding feature information recorded in the forwarding table; and
if the service importance level of the new forwarding feature information is equal to the lowest service importance level among the service importance levels corresponding to the forwarding feature information recorded in the forwarding table, not recording the new forwarding feature information, or deleting a piece of forwarding feature information corresponding to the lowest service importance level in the forwarding table according to a predefined policy, recording the new forwarding feature information into the forwarding table and recording the service importance level corresponding to the new forwarding feature information.

4. The method according to claim 2, wherein the deleting a piece of forwarding feature information corresponding to the lowest service importance level in the forwarding table comprises:
if there is only one piece of forwarding feature information corresponding to the lowest service importance level in the forwarding table, deleting the only one piece of forwarding feature information corresponding to the lowest service importance level, recording the new forwarding feature information into the forwarding table, and recording the service importance level corresponding to the new forwarding feature information; and
if there are multiple pieces of forwarding feature information corresponding to the lowest service importance level in the forwarding table, selecting and deleting one piece of information among the multiple pieces of forwarding feature information corresponding to the lowest service importance level according to a predefined policy, recording the new forwarding feature information into the forwarding table, and recording the service importance level corresponding to the new forwarding feature information.

5. The method according to claim 2, wherein the recording the service importance level comprises: recording the service importance level into the forwarding table, or recording the service importance level into a separate service importance information table.

6. The method according to claim 2, wherein the predetermined policy is that a piece of forwarding feature information is selected randomly, or a piece of forwarding feature information, which is closest to aging, is selected, or a piece of forwarding feature information, which was the first to be learnt, is selected.

7. The method according to claim 2, wherein the service importance level is configured manually or is generated automatically according to signaling.

8. A device for learning forwarding feature information, comprising:
a forwarding table storing module adapted to store forwarding table recording the forwarding feature information;
a service importance level table storing module adapted to record service importance levels corresponding to the forwarding feature information recorded in the forwarding table; and
a forwarding feature information processing module adapted to determine whether the forwarding table is full upon reception of new forwarding feature information; and if full, determine whether to write the new forwarding feature information into the forwarding table according to a service importance level of the new forwarding feature information; otherwise, add the new forwarding feature information into the forwarding table and record the corresponding service importance level.

9. The device according to claim 8, wherein the forwarding feature information processing module further comprises: a determination module adapted to determine whether the service importance level of the new forwarding feature information is higher than the lowest one among the service importance levels corresponding to the forwarding feature information recorded in the forwarding table, wherein if the forwarding table is full and if the service importance level of the new forwarding feature information is higher than the lowest service importance level among service importance levels corresponding to the forwarding feature information recorded in the forwarding table, delete a piece of forwarding feature information corresponding to the lowest service importance level, record the new forwarding feature information into the forwarding table, and record the service importance level corresponding to the new forwarding feature information into the forwarding feature information processing module.

10. The device according to claim 8, wherein:
the forwarding feature information processing module does not record the new forwarding feature information if the service importance level of the new forwarding feature information is lower than the lowest one among the service importance levels corresponding to the forwarding feature information recorded in the forwarding table; and
if the service importance level of the new forwarding feature information is equal to the lowest service importance level among the service importance levels corresponding to the forwarding feature information recorded in the forwarding table, the forwarding feature information processing module does not record the new forwarding feature information, or deletes a piece of forwarding feature information corresponding to the lowest service importance level in the forwarding table according to a predefined policy, records the new forwarding feature information into the forwarding table, and records the service importance level corresponding to the new forwarding feature information into the service importance level table storing module.

11. The device according to claim 8, wherein the forwarding feature information processing module comprises:
a service importance level retrieving module adapted to retrieve the lowest one among the service importance level corresponding to the new forwarding feature information and recorded service importance levels; and
a forwarding information recording module adapted to delete the forwarding feature information corresponding to the lowest service importance level, to record the new forwarding feature information into the forwarding table, and to record the service importance level corresponding to the new forwarding feature information into the service importance level table storing module.
